(19) United States
(12) Patent Application Publication
(10) Pub. No.: US 2007/0116943 A1
(43) Pub. Date: May 24, 2007

(54) Method for making holograms

(76) Inventors: Peter Sinclair, Buchs (GB); Mark Watson, Oxon (GB)

Correspondence Address: WESTERMAN, HATTORI, DANIELS & ADRIAN, LLP, 1250 CONNECTICUT AVENUE, NW, SUITE 700, WASHINGTON, DC, 20036, US

(21) Appl. No.: 10/482,129

(22) PCT Filed: Jun. 25, 2002
(86) PCT No.: PCT/GB02/02754

§ 371 Date: Jul. 1, 2004

(30) Foreign Application Priority Data
Jun. 28, 2001 (GB) 0115814.6

(51) Int. Cl. B32B 27/30; B32B 27/20; B32B 3/26; B05D 3/12; B05D 1/12; B05D 3/02

(52) U.S. Cl. 428/313.5; 428/411.1; 428/522; 428/500; 427/355; 427/180; 427/314

(57) ABSTRACT

A durable holographically imaged paper, plastic film or other product is produced by embossing the image into a thermoplastic coating thereon which comprises plastic pigment particles. The plastic pigment particles are preferably hollow but may be solid. The coating preferably also comprises a thermoplastic polymer or copolymer, for example a copolymer of vinyl acetate and versatic acid, an acrylic polymer, a styrene-acrylic or other acrylic copolymer, a vinyl chloride-vinyl acetate-ethylene terpolymer, a polyvinyl acetate or a polyvinyl alcohol. Preferably, the polymer or copolymer has a glass transition temperature (Tg value) in the range 20° C. to 110° C. The thermoplastic coating may also contain inorganic pigments, for example precipitated calcium carbonate (PCC), ground natural calcium carbonate, or kaolin or other clays, and/or a starch binder. Embossing is preferably carried out directly on the thermoplastic coating by means of a holographically engraved shim.

This invention relates to the production of holographic images, and more particularly to coating compositions which facilitate the production of holographic images by embossing. Such holographic images can be used for decorative effect or as a security feature which is difficult to counterfeit.

Holographic images can be produced by direct embossing of thermally-softened thermoplastic materials. The thermoplastic material is typically in continuous or cut sheet form, and may constitute the sheet itself. Alternatively, the thermoplastic material may be present as a coating on a sheet substrate which itself is not thermoplastic or is thermoplastic to only a limited extent. Suitable substrates include paper or certain polyester films. The thermoplastic coatings may be extruded onto the substrate or applied as a water- or solvent-based coating composition by conventional coating techniques. Holographic embossing of thermoplastic coated substrates is disclosed in, for example, International (PCT) Patent Application No. WO89/03760 and U.S. Pat. No. 5,756,183.

Our experience with holographic embossing of non-extruded thermoplastic coating compositions on paper substrates is that the embossed pattern is not retained satisfactorily over time and/or that the embossing conditions required are so severe as to be liable to damage the substrate or the coating or both.

We have now found that these problems can be eliminated or reduced by incorporating a proportion of plastic pigment particles in the coating composition, and that this expedient also enhances the printability of the embossed and non-embossed areas of the embossed material by decreasing the ink drying time. This enhancement of printability can be very significant for certain end uses of the embossed product, for example where the embossed pattern is for decoration of a printing paper for packaging or other uses where an attractive or unusual sheet appearance is important, or for security applications. Since plastic pigment particles are themselves thermoplastic, they can if desired constitute all of the thermoplastic material in the coating composition, although we do not regard this as preferred.

Accordingly, the present invention provides, in a first aspect, a method of producing a holographically imaged product by embossing the image into a thermoplastic coating on a substrate, characterised in that the coating comprises plastic pigment particles, and, preferably, a thermoplastic polymer or copolymer in addition to said particles.

In a second aspect, the present invention resides in a holographically imaged product produced by a method as just defined.

In a third aspect, the present invention resides in the use, in a thermoplastic coating for a sheet or other substrate, of plastic pigment particles for the purpose of enhancing the ability of the coating to accept and retain a holographic image.

In a fourth aspect, the present invention resides in a coated substrate adapted to be embossed with a holographic image, the coating on the substrate comprising a thermoplastic polymer or copolymer, and, in addition to said polymer or copolymer, a proportion of plastic pigment particles.

The plastic pigment particles are preferably of the hollow type.

Plastic pigment particles, including hollow plastic pigment particles, are themselves well-known in the paper industry as constituents of coating compositions. Solid plastic pigments form the subject of Chapter 6 of Tappi Monograph No. 38 entitled “Paper Coating Pigments”, published 1976, and are also the subject of a sub-section on pages 2073 and 2074 of “Pulp & Paper”—Chemistry & Chemical Technology” edited by James P. Casey 3^{rd} Edition, Volume IV, published in 1983 by John Wiley & Sons. Examples of patents on plastic pigments and/or their use in paper coatings are British Patents Nos. 1229503; 1468398 and 1488554. Hollow plastic pigments and their use in paper coatings are disclosed, for example, in British Patents Nos. 1270632 and 1389122; in a paper given at the 1984 Tappi Coating Conference by C. P. Hemenway, J. J. Latimer and J. E. Young entitled “Hollow-Sphere Polymer Pigment in Paper Coating” and in an article entitled “Hollow-Sphere Pigment Improves Gloss, Printability of Paper” by W. J. Haskins and D. I. Lunde in “Pulp & Paper”, May 1989 edition. Similar hollow plastic pigments are also the subject of product information literature published by Rohm & Haas Company of Philadelphia, U.S.A. in relation to its products sold under the trade mark “Ropaque”. A specific example of a suitable hollow plastic pigment particulate material for use in the present invention is “Ropaque HP 1055”, composed of styrene-acrylic polymeric particles.

The present invention is particularly suitable for use with paper or plastic film substrates. If desired, these may carry one or more coatings, for example to enhance the smoothness of the thermoplastic coating or its bonding to the base substrate. Paper substrates are typically coated or uncoated woodfree papers. These may be white or coloured, and opaque or translucent (the last-mentioned may be natural highly refined tracing papers or chemically-transparentized papers). Some examples of suitable base papers, both uncoated and coated, are given in the specific Examples hereafter.

The thermoplastic polymer or copolymer can very widely in both chemical nature and thermal softening characteristics. The latter are conveniently defined in terms of glass transition temperature (Tg value). Preferably the Tg value should be in the range of about 20° C. to about 110° C. Use of a (co)polymer with too low a Tg value can result in a coating which is too tacky, with the result that it is difficult or impossible to remove the holographic embossing surface from the embossed coating without damaging the coating and/or the underlying substrate. On the other hand if the Tg value is too high, the heat required to soften the coating may be excessive.

For the avoidance of doubt, the expression “copolymer” in this specification refers to polymers derived from two or more copolymers, and therefore includes terpolymers, etc.

Copolymers of vinyl acetate and versatic acid (sometimes known as Veova copolymers) have been found to be particularly suitable as thermoplastic material for use in the present coating. Other suitable polymers or copolymers include acrylic polymers, styrene-acrylic or other acrylic copolymers, vinyl chloride-vinyl acetate-ethylene terpolymers, polyvinyl acetate and polyvinyl alcohol. Even a natural polymer such as starch has some thermoplastic properties and can be used, though it is not preferred on its own.

The thermoplastic coating is preferably made up in an aqueous vehicle and optionally also contains inorganic pigments and coating starch. These inorganic pigments can be of the kind conventionally used in paper coating, for example precipitated calcium carbonate (PCC), ground natural calcium carbonate or kaolin or other clays. Such pigments serve as extenders, and can also enhance the printability of the coating. The presence of starch is useful as an extender to reduce costs, to improve the runnability of the coating operation, and to eliminate or control any tackiness of the finished coating which might result from the presence of thermoplastic material. The relative proportions of the constituents of the thermoplastic coating can vary widely but for a composition including optional ingredients as just described, it is typically 40%-60% thermoplastic (co)polymer, 25%-35% hollow plastic pigment particles, 20%-25% maize or other starch and 10%-15% PCC by weight on a dry weight basis. Specific formulations are given in the Examples hereafter.

The minimum effective amount of plastic pigment particles which can be used can be determined by experiment, but our experience suggests that it is about 5-10% by weight on a dry weight basis. Preferably rather more than this amount is used, for example at least 15-20% by weight.

The coatweight of the thermoplastic coating can likewise vary quite widely, but 2 gm⁻² on a dry basis is normally sufficient. It can of course be more than this. The coating technique used for applying the thermoplastic coating is not critical. Suitable coating techniques include air-knife, blade, Meyer bar, gravure and metered size press coating.

The improved embossability afforded by the use of plastic pigment particles permits (a) faster embossing and (b)lower coatweights of thermoplastic (co)polymer to be used than if plastic pigment particles are absent.

Embossing is preferably carried out directly on the thermoplastic coating by means of a holographically engraved shim. Typically the shim is passed through a high pressure nip with its surface pressed against the thermoplastic coating. The high pressure nip may be a pair of calendering bowls. Alternatively, embossing may be carried out using a static press with heated plates which press the holographic shim against the surface to be embossed. The embossing pressure in either case will depend on the nature and softening temperature of the thermoplastic coating. Typically it will be of the order of 5×10⁶ Pa (50 bar) or more.

The thermoplastic coating is preferably pre-heated before the embossing operation, typically to a temperature of the order of 80-150° C., depending on the polymer(s) used. Such pre-heating is conveniently achieved, in the case of continuous sheet material, by passing the material through a low pressure heated nip, or by infra-red heaters. The shim is also preferably preheated, for example by conventional heating of a roll or other support on which it is mounted.

Although we envisage that it will be most practicable to emboss sheet material in continuous web form, it would be possible in principle to carry out embossing either statically or dynamically on cut sheet material, with any desired pre-heating effected by, for example, very low pressure contact with a heated surface.

The invention will now be illustrated by the following Examples, in which all parts and percentages are by weight unless otherwise specified:

### EXAMPLE 1

Two 41% solids content aqueous thermoplastic coating compositions were prepared, one according to the invention and containing hollow plastic pigment particles, and the other with no plastic pigment particles, to serve as a control. The constituents were as follows (parts by weight on a dry basis):

| Constituent | Invention | Control |
|---|---|---|
| Veova copolymer having a Tg value | 75 | 100 |
| of 20° C. (“Emultex* VV579” supplied | | |
| by Harco i.e. Harlow Chemical Ltd. | | |
| Harlow United Kingdom, at a solids | | |
| content of 51%). | | |
| Hollow plastic pigment particles | 25 | — |
| (“Ropaque* HP 1055” supplied by | | |
| Rohm & Haas as a 26.5% solids | | |
| content aqueous dispersion). | | |

*In this and subsequent Examples, an asterisk indicates a proprietary trade mark.

The coating compositions were each coated on to sheets of 100 g m⁻² smooth white uncoated base paper by means of a laboratory Meyer bar coater at a target coatweight of about 8 g m⁻² in each case. The resulting papers were dried in a hot air oven and then were embossed as described below.

A small piece of holographic shim was placed holographic face down on the coated side of the paper, and a sheet of uncoated 100 g m⁻² paper was placed on top. The paper to be embossed and the shim were then preheated to about 100° C. by placing the entire three layer assembly just described between heated plates in a static press at very low pressure. The assembly was then immediately passed through a laboratory steel-steel nip calender so that the holographic image was embossed into the coating. The calender pressure was 10⁷ Pa ( 100 bar) and the embossing speed was about 20 m min⁻¹.

The resulting embossed papers each had a very noticeable hologram image, but the hologram on the control paper was not as visible as that on the paper according to the invention. The hologram on the control paper was observed to fade with time, and could not be seen at all after 5 days. By contrast the hologram on the paper according to the invention had not noticeably faded even after 3 months.

The printability of the two papers (in terms of offset ink drying time) was assessed with an IGT machine using BASF Firecrest* Plus ink. The ink drying time for the paper according to the invention was about 4 to 5 hours, whereas for the control paper it was about 8 hours.

### EXAMPLE 2

The procedure of Example 1 was repeated, except that (a) the Veova copolymer was replaced, dry weight for dry weight, by a cross-linking acrylic polymer having a Tg value of 15° C. (“Vinacryl* 4345”, supplied by Vinamul Limited, Carshalton, UK at 44%-46% solids content) (b) the coating composition was made up at 39% solids content, and (c) no printability testing was carried out.

The hologram on the paper according to the invention was durable, with no noticeable fading after 3 months, whereas that on the control paper faded rapidly and had disappeared after 1 day.

### EXAMPLE 3

The procedure of Example 1 was repeated, except that (a) Veova copolymer was replaced by a cross-linking vinyl chloride-vinyl acetate-ethylene terpolymer having a Tg value of about 60° C. (“Vinacryl* 3525, supplied by Vinamul Limited at 49%-51% solids content) (b) 64 parts by weight terpolymer and 36 parts by weight of hollow plastic pigment particles were used (c) the coating composition was made up at 39% solids content and (d) the target dry coatweight was about 7 g m⁻².

The hologram on the paper according to the invention was of very good quality, and appeared permanent, with no noticeable change after 3 weeks. By contrast, the hologram on the control paper was of only fair quality initially, and had disappeared after 10 days.

The offset ink drying times on the paper according to the invention and the control paper were about 3 hours and 5 hours respectively.

### EXAMPLE 4

This illustrates the inclusion of inorganic pigment particles as well as hollow plastic pigment particles.

A 44% solids content aqueous coating composition was made up from the following constituents (parts by weight on a dry basis):

| | |
|---|---|
| Terpolymer as in Example 3 | 56 |
| Hollow plastic pigment particles | 30 |
| (“Ropaque* HP1055”) | |
| PCC (“Calopake* F” supplied by | 14 |
| Rhone Poulenc) | |

This was coated and tested as described in Example 3, with a target dry coatweight of 6 g m⁻². A very good holographic image was obtained, with no observed fading. The offset drying time was 2 hours.

### EXAMPLE 5

This illustrates the use of solid rather than hollow plastic pigment particles.

The procedure of Example 4 was repeated except that (a) a cationic solid styrene-acrylic plastic pigment of 70 nm average particle diameter and a Tg value of 70-80° C. (“X CPP100” supplied by Mitsui Chemicals Inc. at 30% solids content) was used as a dry weight for dry weight replacement for the hollow plastic pigment particles (b) the solids content of the coating composition was 48% and (c)the target dry coatweight was 8 g m⁻².

The hologram quality obtained was good (although not quite as good as in Example 4) and there was no observed fading after 3 weeks. The offset drying time was as in Example 4.

### EXAMPLE 6

This illustrates the inclusion of both starch and an inorganic pigment in the coating composition with the plastic pigment particles.

A 24% solids content aqueous coating composition was made up from the following constituents (parts by weight on a dry basis):

constituents (parts by weight on a dry basis):

| | |
|---|---|
| Veova copolymer (“Emultex* VV579”) | 45 |
| Hollow plastic pigment particles | 25 |
| (“Ropaque* HP 1055”) | |
| Maize starch (“Cerestar* 05590” | 20 |
| supplied by Cerestar) | |
| PCC (“Calopake* F”) | 10 |
| | 100 |

The coating composition was coated on to a smooth pigment coated 160 g m⁻² paper (Alter Ego* manufactured by Arjo Wiggins Papiers Couchés, Issy-les-Moulineaux, France) by means of an air-knife coater at target coatweights in the range of 3-8 gm⁻².

The resulting papers were tested as described in previous Examples. The hologram quality was good in each case, with no observed fading after 2 weeks. It was observed that the coatweight appeared to have little influence on hologram quality, i.e. the hologram obtained on the 3 g m⁻² coatweight paper was not significantly different from those obtained at higher coatweights.

### EXAMPLE 7

This was similar to Example 6, except that no starch was used. The coating composition was made up at 25% solids content, with 58.2 parts Veova copolymer, 31.8 parts hollow plastic pigment particles and 10 parts PCC. Runnability during the coating operation was slightly worse than for Example 6.

The holographic emboss quality obtained was as described for Example 6, but the embossed coating was slightly more tacky, and therefore more difficult to release from the holographic shim. It was also observed that the coating pattern was slightly worse than for the Example 6 paper.

### EXAMPLE 8

This illustrates the use of hollow plastic pigment particles as the only thermoplastic material in the coating.

A 21% solids content aqueous coating composition was made up using, on a dry weight basis, 65 parts hollow plastic pigment particles and 35 parts maize starch (both as used in previous Examples). This was coated on to a 100 g m⁻² white uncoated woodfree base paper at a target coatweight of about 5 g m⁻², using a Meyer bar coater. The resulting paper was embossed, after drying, as described in previous Examples.

A holographic image of acceptable quality was obtained, although it was not as good as those obtained when other thermoplastic polymers were present. There was no observed fading of the hologram after 2 weeks.

### EXAMPLE 9

A 27% solids content aqueous coating composition was made up from the following constituents (parts by weight on a dry basis):

| | |
|---|---|
| Acrylic copolymer of Tg 105° C. | 45 |
| (“Xenacryl* DP9B/1335”, supplied | |
| by Baxenden Chemicals Ltd. Baxenden, | |
| United Kingdom, at 40% solids content). | |
| Hollow plastic pigment particles | 20 |
| (“Ropaque* HP1055”) | |
| Maize starch (“Cerestar* 05590”) | 25 |
| PCC (“Calopake* F”) | 10 |

This composition was coated on to a paper as described in Example 8 at a target coatweight of 5 g m⁻². After drying, the paper was preheated to 150° C. by very low pressure contact with a hot plate and then embossed as described in previous Examples but at a pressure of 1.5×10⁷ Pa (150 bar).

A good quality holographic image was obtained, and there was no observed fading of the hologram after 3 weeks.

1. A method of producing a holographically imaged product by embossing the image into a thermoplastic coating on a substrate, wherein the coating comprises plastic pigment particles.

2. A method as claimed in claim 1, wherein the coating comprises a thermoplastic polymer or copolymer in addition to said particles.

3. A method as claimed in claim 2, wherein the glass transition temperature (Tg value) of the polymer or copolymer is in the range of about 20° C. to about 110° C.

4. A method as claimed in claim 3, wherein the polymer or copolymer is a copolymer of vinyl acetate and versatic acid, an acrylic polymer, a styrene-acrylic or other acrylic copolymer, a vinyl chloride-vinyl acetate-ethylene terpolymer, a polyvinyl acetate or a polyvinyl alcohol.

5. A method as claimed in claim 1, wherein the thermoplastic coating also contains inorganic pigments, for example precipitated calcium carbonate (PCC), ground natural calcium carbonate, or kaolin or other clays.

6. A method as claimed in claim 1, wherein the thermoplastic coating contains a starch binder.

7. A method as claimed in claim 1, wherein the thermoplastic coating contains at least 5% by weight, preferably at least 10% by weight, more preferably at least 15% by weight, of plastic pigment particles on a dry weight basis.

8. A method as claimed in claim 1, wherein at least some of the plastic pigment particles are of the hollow type.

9. A method as claimed in claim 8, wherein the coating comprises 40%-60% thermoplastic (co)polymer, 25%-35% hollow plastic pigment particles, 20%-25% starch and 10%-15% precipitated calcium carbonate by weight on a dry weight basis.

10. A method as claimed in claim 1 wherein the coatweight of the thermoplastic coating is at least 2 gm⁻² on a dry basis.

11. A method as claimed in claim 1, wherein embossing is carried out directly on the thermoplastic coating by means of a holographically engraved shim.

12. A method as claimed in claim 11, wherein the embossing pressure is 5×10⁶ Pa (50 bar) or more.

13. A method as claimed in claim 11 wherein the shim is preheated, for example by conventional heating of a roll or other support on which it is mounted.

14. A method as claimed in claim 1, wherein the thermoplastic coating is pre-heated before the embossing operation.

15. A method as claimed in claim 1 wherein the substrate is paper or plastic film.

16. A method as claimed in claim 15, wherein the substrate is an optionally coated white or colored opaque or translucent woodfree paper.

17. A method as claimed in claim 15, wherein the substrate carries one or more coatings to enhance the smoothness of the thermoplastic coating or its bonding to the base substrate.

18. A holographically imaged product produced by a method as claimed in claim 1.

19. The use, in a thermoplastic coating for a sheet or other substrate, of plastic pigment particles for the purpose of enhancing the ability of the coating to accept and retain a holographic image.

20. A coated substrate adapted to be embossed with a holographic image, the coating on the substrate comprising a thermoplastic polymer or copolymer, and, in addition to said polymer or copolymer, a proportion of plastic pigment particles, and, optionally a starch binder and/or inorganic pigment(s).

21. A coated substrate as claimed in claim 20, wherein the glass transition temperature (Tg value) of the polymer or copolymer is in the range of about 20° C. to about 110° C.

22. A coated substrate as claimed in claim 21, wherein the polymer or copolymer is a copolymer of vinyl acetate and versatic acid, an acrylic polymer, a styrene-acrylic or other acrylic copolymer, a vinyl chloride-vinyl acetate-ethylene terpolymer, a polyvinyl acetate or a polyvinyl alcohol.

23. A coated substrate as claimed in claimed in claim 20, wherein the thermoplastic coating contains at least 5% by weight, preferably at least 10% by weight, more preferably at least 15% by weight, of plastic pigment particles on a dry weight basis.

24. A coated substrate as claimed in claim 20, wherein at least some of the plastic pigment particles are of the hollow type.

25. A coated substrate as claimed in claim 24, wherein the coating comprises 40%-60% thermoplastic (co)polymer, 25%-35% hollow plastic pigment particles, 20%-25% starch and 10%-15% precipitated calcium carbonate by weight on a dry weight basis.
